(19) United States
(12) Patent Application Publication
(10) Pub. No.: US 2015/0213484 A1
(43) Pub. Date: Jul. 30, 2015

(54) SYSTEM AND METHOD FOR TRACKING RELATED EVENTS

(71) Applicants: ASHOK AMARA, San Jose, CA (US); Sagnik Nandy, Los Gatos, CA (US); Chao Cai, San Jose, CA (US); Zhimin He, Sunnyvale, CA (US); Alex J. Lorbeer, Hoboken, NJ (US); Eric W. Ewald, Mountain View, CA (US)

(72) Inventors: ASHOK AMARA, San Jose, CA (US); Sagnik Nandy, Los Gatos, CA (US); Chao Cai, San Jose, CA (US); Zhimin He, Sunnyvale, CA (US); Alex J. Lorbeer, Hoboken, NJ (US); Eric W. Ewald, Mountain View, CA (US)

(21) Appl. No.: 12/729,137

(22) Filed: Mar. 22, 2010

(51) Int. Cl. G06Q 30/02; H04L 29/08

(52) U.S. Cl. CPC G06Q 30/0246; H04L 67/22

(57) ABSTRACT

A system and method for tracking conversion events. Tracking events are stored in a history table of a database, wherein the tracking events include conversion events associated with predetermined actions performed by users on websites, and wherein a respective tracking event is associated with a respective user and a respective website. A conversion event stored in the history table of the database is identified, wherein the conversion event is associated with a predetermined action performed by a user on a website. A set of tracking events is retrieved from the history table that are associated with the website, that are associated with the user, and that occurred prior in time to the conversion event. In response to a request from a user request, a report is generated for display on a client computer system, wherein the report includes the set of tracking events and the conversion event.

### TECHNICAL FIELD

The disclosed embodiments relate generally to tracking related events. In particular, the disclose embodiments relate to a system and method for tracking a sequence of events preceding conversion events based on Internet traffic data.

### BACKGROUND

Internet traffic data may be analyzed to gain insight into the behavior of Internet users. For example, search queries and corresponding user clicks on search results may be used to improve search results for future search queries. However, there is presently no way to track related search queries of a respective user that led to a click on a search result. Similarly, web analytics systems allow an operator of a web site to obtain statistics about requests for web pages made by visitors to the web site. The statistics may also include statistics about the effectiveness of advertisement campaigns. For example, an operator of a website may be interested in the number of impressions (i.e., the number of views of an advertisement campaign), the number of click-throughs (i.e., the number of clicks the advertisement campaign received), and the number of conversions (i.e., the number of people that performed a desired action associated with the advertisement campaign) for the advertisement campaign. Although these statistics are useful for gauging the success of an advertisement campaign, these statistics do not allow the operator of the website to understand the sequence of events that led up to a conversion.

### SUMMARY

Some embodiments provide a system, a computer-readable storage medium including instructions, and a computer-implemented method for tracking conversion events. Tracking events are stored in a history table of a database, wherein the tracking events include conversion events associated with predetermined actions performed by users on websites, and wherein a respective tracking event is associated with a respective user and a respective website. A conversion event then stored in the history table of the database is identified, wherein the conversion event is associated with a predetermined action performed by a user on a website. Next, a set of tracking events is retrieved from the history table that are associated with the website, that are associated with the user, and that occurred prior in time to the conversion event. In response to a request from a user request, a report is generated for display on a client computer system, wherein the report includes the set of tracking events and the conversion event.

In some embodiments, a respective tracking event is selected from the group consisting of a conversion event that is generated when a user performs a predetermined action on a website, an impression event that is generated when an advertisement is displayed to a user, and a click-through event that is generated when a user clicks on an advertisement.

In some embodiments, the predetermined action performed by the user is selected from the group consisting of purchasing a product or service associated with the advertisement, visiting a website associated with the advertisement, and completing a survey.

In some embodiments, prior to storing the tracking events in the history table of the database, the tracking events are periodically obtained from log files.

In some embodiments, the database is a distributed database.

In some embodiments, the distributed database is a multi-dimensional sorted map.

In some embodiments, a respective tracking event is stored into the distributed database as follows. An event type of the respective tracking event is determined. A row name is generated based on an identifier of a respective website associated with the respective tracking event and an identifier of a user associated with the respective tracking event. Data for the respective tracking event is stored in a respective entry of the distributed database, wherein the respective entry has an index based on the row name, the event type, and a timestamp corresponding to a time when the respective tracking event was generated.

In some embodiments, locality groups of the distributed database are designated based on the event types of the tracking events.

In some embodiments, a first locality group includes conversion events, and a second locality group includes impression events and click-through events.

In some embodiments, the conversion event stored in the history table of the database is identified as follows. A conditional read against the first locality group is performed to retrieve one or more conversion events stored in the history table. The conversion event is then selected from the one or more conversion events.

In some embodiments, an aggregated view of tracking events for a respective website is periodically generated across all users that performed the predetermined action on the respective website.

In some embodiments, tracking events are periodically removed from the history table based on a garbage collection policy.

In some embodiments, the garbage collection policy is selected from the group consisting of a time-based garbage collection policy that removes tracking events older than a predetermined age, a user-based garbage collection policy that removes tracking events based on an identifier of a user, and a website-based garbage collection policy that removes tracking events based on an identifier of a website.

In some embodiments, the website is selected from the group consisting of an e-commerce website, an auction website, a multimedia-download website, a charitable contribution website, and a survey website.

In some embodiments, the set of tracking events that are retrieved from the history table include only the tracking events that occurred within a predetermined time interval prior in time to occurrence of the conversion event.

### BRIEF DESCRIPTION OF THE DRAWINGS

FIG. 1 is an overview block diagram of a client-server server system for tracking conversion events, according to some embodiments.

FIG. 2 is a block diagram of an exemplary data structure that stores traffic data at different web sites, according to some embodiments.

FIG. 3 is a block diagram illustrating the process of generating reports of tracking events, according to some embodiments.

FIG. 4 is a block diagram illustrating an exemplary history table, according to some embodiments.

FIG. 5 is a block diagram of a client device for accessing web analytics data, according to some embodiments.

FIG. 6 is a block diagram of a server system for presenting and providing access to custom variables for web analytics to be displayed at a requesting client device, according to some embodiments.

FIG. 7 is a block diagram of a web server for serving web pages to client devices, according to some embodiments.

FIG. 8 is a block diagram of a web server for logging accesses by users of web sites hosted on one or more web servers, according to some embodiments.

FIG. 9 is a flowchart of a method for tracking conversion events, according to some embodiments.

FIG. 10 is a flowchart of a method for storing tracking events in a history table of a database, according to some embodiments.

FIG. 11 is a flowchart of a method for identifying a conversion event stored in the history table of the database, according to some embodiments.

FIG. 12 is a screenshot illustrating an exemplary report, according to some embodiments.

Like reference numerals refer to corresponding parts throughout the drawings.

### DESCRIPTION OF EMBODIMENTS

Reference will now be made in detail to embodiments, examples of which are illustrated in the accompanying drawings. While the invention will be described in conjunction with the embodiments, it will be understood that the invention is not limited to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

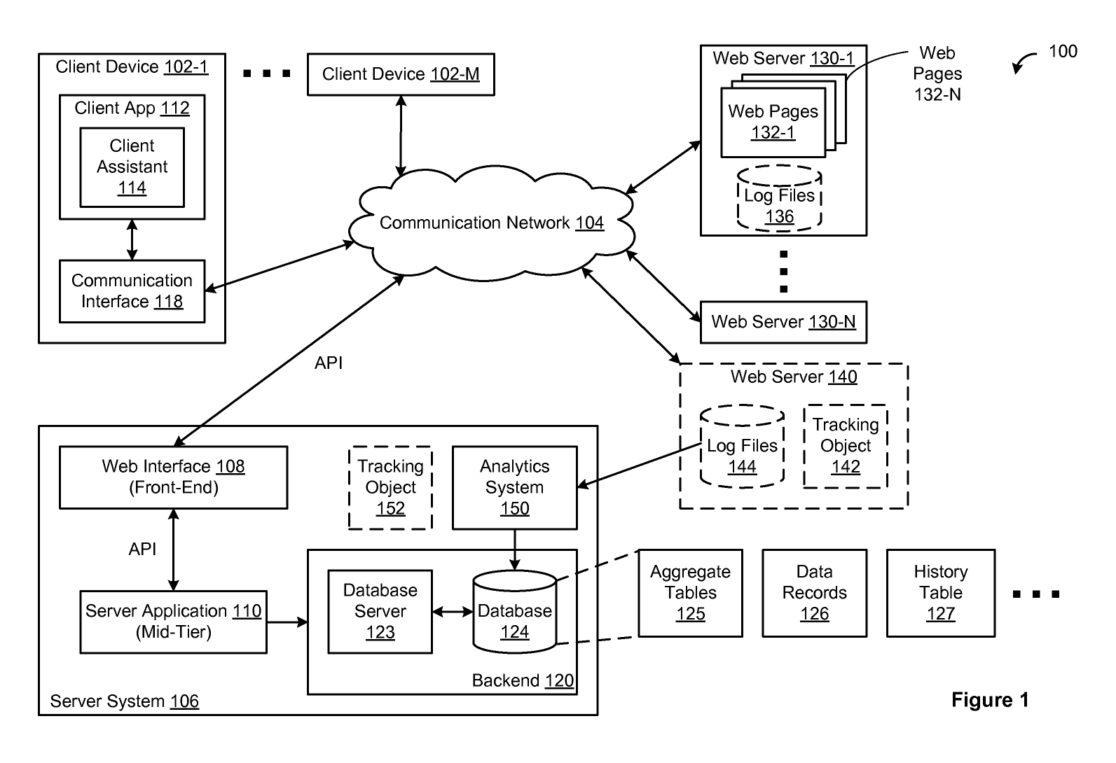

FIG. 1 is an overview block diagram of a client-server server system 100 for tracking conversion events in accordance with some embodiments. Note that a conversion event is generated when a user performs a predetermined action on a website (e.g., purchasing a product or service associated with the advertisement, visiting a website associated with the advertisement, and completing a survey, etc.). The client-server server system 100 includes a plurality of client devices 102 connected to a server system 106 through one or more communication networks 104.

A client device 102 (also known as a “client”) may be any computer or similar device through which a user of the client device 102 can submit data access requests to and receive results or other services from the server system 106, web servers 130, and/or web server 140. Examples include, without limitation, desktop computers, laptop computers, tablet computers, mobile devices such as mobile phones, personal digital assistants, set-top boxes, or any combination of the above. A respective client 102 may contain at least one client application 112 for submitting requests to the server system 106, the web servers 130, and/or the web server 140. For example, the client application 112 can be a web browser or other type of application that permits a user to access the services provided by the server system 106, the web servers 130, and/or the web server 140.

In some embodiments, the client application 112 includes one or more client assistants 114. A client assistant 114 can be a software application that performs tasks related to assisting a user's activities with respect to the client application 112 and/or other applications. For example, the client assistant 114 may assist a user at the client device 102 with browsing information (e.g., web pages retrieved from the web servers 130 and/or 140), processing information (e.g., query results) received from the server system 106, and monitoring the user's activities on the query results. In some embodiments, the client assistant 114 is embedded in a web page (e.g., a query results web page) or other documents downloaded from the server system 106. In some embodiments, the client assistant 114 is a part of the client application 112 (e.g., a plug-in application of a web browser). The client 102 further includes a communication interface 118 to support the communication between the client 102 and other devices (e.g., the server system 106 or another client device 102).

The communication network(s) 104 can be any wired or wireless local area network (LAN) and/or wide area network (WAN), such as an intranet, an extranet, the Internet, or a combination of such networks. In some embodiments, the communication network 104 uses the HyperText Transport Protocol (HTTP) and the Transmission Control Protocol/Internet Protocol (TCP/IP) to transport information between different networks. The HTTP permits client devices to access various information items available on the Internet via the communication network 104. The various embodiments of the invention, however, are not limited to the use of any particular protocol.

In some embodiments, the server system 106 includes a web interface 108 (also referred to as a “front-end server”), a server application 110 (also referred to as a “mid-tier server”), and a backend server 120. The web interface 108 receives data access requests from client devices 102 and forwards the requests to the server application 110. In response to receiving the requests, the server application 110 decides how to process the requests including identifying data filters associated with a request, checking whether it has data available for the request, submitting queries to the backend 120 for data requested by the client, processing the data returned by the backend 120 that matches the queries, and returning the processed data as results to the requesting clients 102. After receiving a result, the client application 112 at a particular client 102 displays the result to the user who submits the original request.

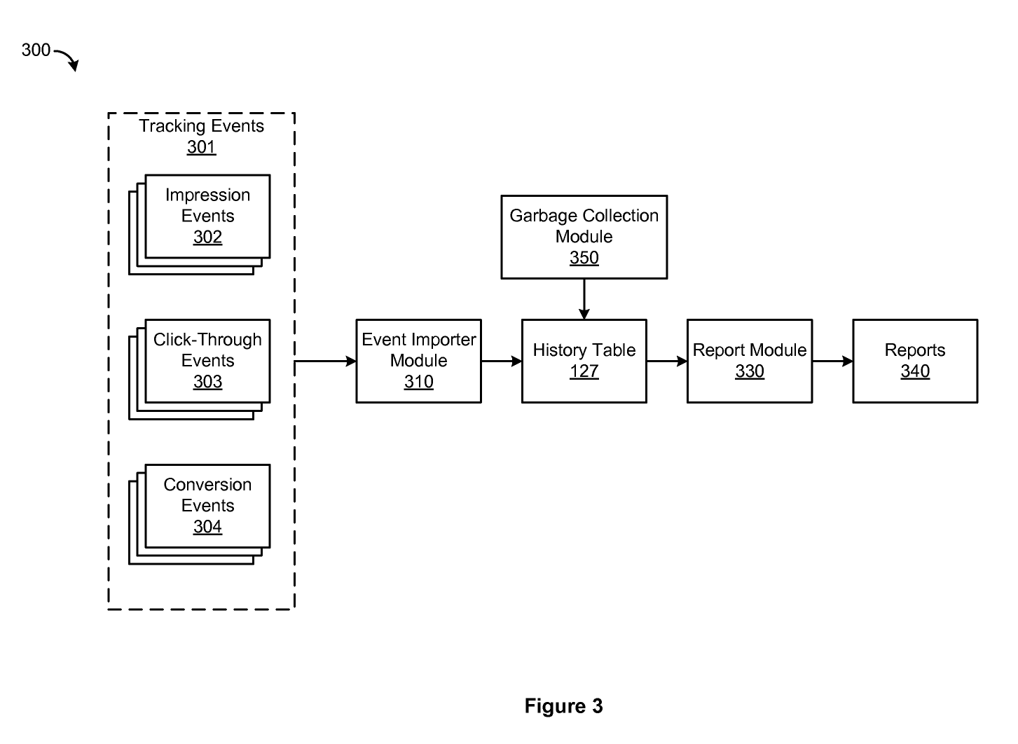

In some embodiments, the backend 120 is effectively a database management system including a database server 123 that is configured to manage a database 124. In some embodiments, the database 124 is stored at the server system 106. In some embodiments, the database 124 is located on a computer system that is separate and distinct from the server system 106. In some embodiments, the database 124 includes aggregate tables 125. Aggregate tables include data that is aggregated on a periodic basis and allows the server system 106 to quickly provide results for data that is commonly requested. In some embodiments, the database 124 includes data records 126. In response to a query submitted by the server application 110, the database server 123 identifies zero or more data records that satisfy the query and returns the data records to the server application 110 for further processing. In some embodiments, the database 124 includes a history table 127 that stores tracking events. In some embodiments, the tracking events include a conversion event that is generated when a user performs a predetermined action on a website, an impression event that is generated when an advertisement is displayed to a user, and/or a click-through event that is generated when a user clicks on an advertisement. In some embodiments, the website is selected from the group consisting of an e-commerce website, an auction website, a multimedia-download website, a charitable contribution website, and a survey website. These embodiments are described in more detail with respect to FIGS. 3-4 and 9-11 below.

In some embodiments, the database 124 is a distributed database. In some embodiments, the distributed database is a multi-dimensional sorted map. For example, the multi-dimensional sorted map may be a BigTable.

In some embodiments, the server system 106 is an application service provider (ASP) that provides web analytics services to its customers (e.g., a web site owner) by visualizing the traffic data generated at a web site in accordance with various user requests. To do so, the server system 106 may include an analytics system 150 adapted for processing the raw traffic data of a web server 130 and other types of traffic data generated by the web server 130 through techniques such as page tagging. Note that the traffic data may include any type of user traffic (e.g., requests for static or dynamic web pages, traffic from mobile applications, requests by and request for Flash applications, etc.). In some embodiments, the traffic data includes tracking events produced from user actions on the web servers 130. In some embodiments, the server system 106 analyzes the traffic data to identify tracking events that lead up to a conversion event. For example, the server system 106 may identify a conversion event produced by actions of a user on a first website. Based on the conversion event, the server system 106 may then identify all (or a subset of) the tracking events (e.g., impression events, click-through events, and/or conversion events) associated with the user and the first website that occurred prior in time to the particular conversion event. Note that the tracking events can be generated in response to actions of a user other websites (e.g., websites other than the first website).

In some embodiments, the raw traffic data is obtained from log files 136 of the web servers 130. In these embodiments, the web servers 130 provide access to the log files 136 to the analytics system 150.

In some embodiments, the raw traffic data is obtained from log files 144 of a web server 140. In these embodiments, content providers insert tracking code (e.g., a script) into documents (e.g., web pages 132) for which the content providers desire to obtain traffic data. When these documents are accessed by users, the tracking code is executed and a request for a tracking object 142 (e.g., a specified image file) on the web server 140 is generated. In some embodiments, the request for the tracking object 142 includes parameters that provide information about the page being requested. The request for the tracking object 142 is recorded in the log files 144, including any parameters associated with the request for the tracking object. In some embodiments, the web servers 130 include the tracking object 142 that the analytics system 150 uses to track hits to web pages 132. In these embodiments, the analytics system 150 obtains the log files from the web servers 130.

In some embodiments, the raw traffic data is transmitted directly from the client devices 102 to the analytics system 150. In these embodiments, content providers insert tracking code (e.g., a script) into documents (e.g., web pages 132) for which the content providers desire to obtain traffic data. When these documents are accessed by users, the tracking code is executed by the client devices 132 and a request for a tracking object 152 (e.g., a specified image file) on the server system 106 is generated. The analytics system 150 receives the request from the client devices 132, processes the raw traffic data, and stores attribute-value pairs associated with the raw traffic data in the database 124. In some embodiments, the request for the tracking object 152 includes parameters that provide information about the page being requested.

In some embodiments, the tracking object 142 (or 152) is a tracking object for an advertisement associated with a website. In these embodiments, when a client assistant (e.g., the client assistant 114) of a client device (e.g., the client device 102-1) displays the advertisement associated with the website, the client assistant executes code associated with the advertisement that generates a request for the tracking object 142 (or 152), wherein the request includes parameters indicating that the advertisement was displayed (i.e., an impression of the advertisement was produced). This request for the tracking object 142 (or 152) generates an impression event in the log files 144 (or an impression event on the server system 106). When a user of the client device clicks on the displayed advertisement, client assistant executes code associated with the advertisement that generates a request for the tracking object 142 (or 152), wherein the request includes parameters indicating that the advertisement was clicked (i.e., a click-through of the advertisement was produced). This request for the tracking object 142 (or 152) generates a click-through event in the log files 144 (or a click-through event on the server system 106). When a user performs a predetermined action on the website associated with the advertisement, the website (or alternatively, the client assistant 114) generates a request for the tracking object 142 (or 152) that includes parameters indicating that the predetermined action on the website was performed by the user. This request for the tracking object 142 (or 152) generates a conversion event in the log files 144 (or a conversion event on the server system 106). Note that the user may have been shown the advertisement and/or the user may have clicked on the advertisement a number of times over a period of time prior to performing the predetermined action on the website associated with the advertisement (i.e., generating the conversion event). The embodiments described herein disclose techniques for tracking the tracking events leading up to the conversion event.

Note that in any of the aforementioned techniques, the raw traffic data may be included in an activity file. For example, the activity file may be the log files 136, the log files 144, or the raw traffic data received directly from the client devices 132. Also note that for the sake of clarity, the disclosed embodiments are described with respect to using the web server 140 to tracking requests web pages of a web site using the tracking object 142 and log files 144. However, any of the techniques for acquiring raw traffic data may be used. Furthermore, note that any technique for tracking raw traffic data may be used. For example, the raw traffic data may be stored in cookies on a client computer system that is periodically transmitted to the server system 106 for analysis, as described herein. Similarly, the raw traffic data may be stored on a client computer system (e.g., using a cookie, a database, etc.) and analyzed locally on the client computer system using the techniques described herein. The analyzed data may then transmitted to the server system 106 for storage.

After the raw traffic data is obtained from the activity files, the raw web traffic data is first processed into a multidimensional dataset that includes multiple dimensions and multiple metric attributes (or measures) before the server system 106 can answer any data visualization requests through the web interface 108. A more detailed description of the processing of raw web traffic data can be found in the U.S. Provisional Patent Application No. 61/181,275, filed May 26, 2009, entitled “System and Method for Aggregating Analytics Data” (attorney docket no. 060963-5406-PR) and the U.S. Provisional Patent Application No. 61/181,276, filed May 26, 2009, entitled “Dynamically Generating Aggregate Tables” (attorney docket no. 060963-5409-PR), the contents of which are incorporated by reference herein in their entirety. For simplicity, it is assumed herein that the data records managed by the backend 120 and accessible to the server application 110 are not the raw web traffic data, but the data after being pre-processed. Note that the traffic data may be sessionized and/or aggregated.

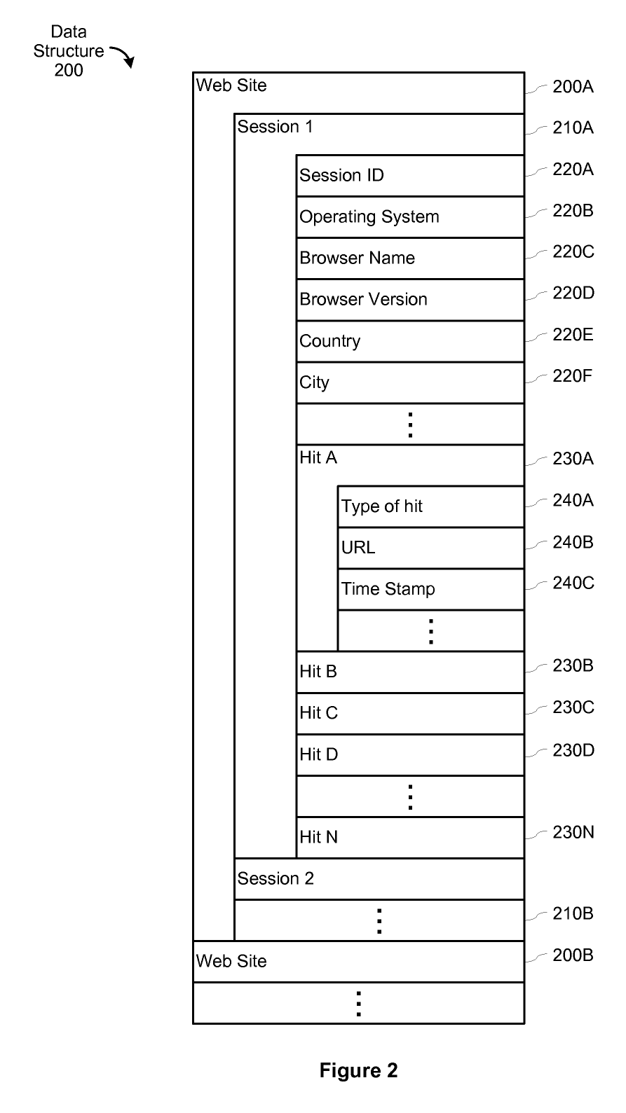

FIG. 2 is a block diagram of a data structure 200 used for storing the pre-processed web traffic data at different web sites in accordance with some embodiments. The web data stored in the data structure 200 have a hierarchical structure. The top level of the hierarchy corresponds to different web sites 200A, 200B (i.e., different web servers). For a respective web site, the traffic data is grouped into multiple sessions 210A, 210B, each session having a unique session ID 220. A session ID uniquely identifies a user's session with the web site 200A for the duration of that user's visit. Within a session 210A, other session-level attributes include operating system 220B (i.e., the operating system the computer runs on from which the user accesses the web site), browser name 220C (i.e., the web browser application used by the user for accessing the web site) and browser version 220D, geographical information of the computer such as the country 220E and the city 220F, etc.

For convenience and custom, the web traffic data of a user session (or a visit) is further divided into one or more hits 230A to 230N. Note that hits 230A to 230N are also referred to as “hit records” or “database hit records” 230A to 230N. Also note that the terms “session” and “visit” are used interchangeably throughout this application. In the context of web traffic, a hit typically corresponds to a request to a web server for a document such as a web page, an image, a JavaScript file, a Cascading Style Sheet (CSS) file, etc. Each hit 230A may be characterized by attributes such as type of hit 240A (e.g., transaction hit, etc.), referral URL 240B (i.e., the web page the visitor was on when the hit was generated), a timestamp 240C that indicates when the hit occurs and so on. Note that the session-level and hit-level attributes as shown in FIG. 2 are listed for illustrative purposes only. As will be shown in the examples below, a session or a hit may have many other attributes that either exist in the raw traffic data (e.g., the timestamp) or can be derived from the raw traffic data by the analytics system 150 (e.g., the average page views per session).

Referring back to FIG. 1, a user at a client device 102 submits a request to the server system 106 for generating a report of the web traffic data associated with a particular web site. Upon receipt of the request, the server application 110 generates or identifies one or more queries and submits the queries to the backend server 120 that manages the web site's “sessionized” traffic data in the data structure 200 and processes the query results returned by the backend server 120 such that they can be visualized at the client device 102 in the form of a web analytics report. Note that the traffic data may also be aggregated.

The process of generating a web analytics report is described in detail in U.S. patent application Ser. No. 12/575,437, filed Oct. 7, 2009, entitled “Method and System for Generating and Sharing Dataset Segmentation Schemes,” the content of which is incorporated by reference herein in its entirety.

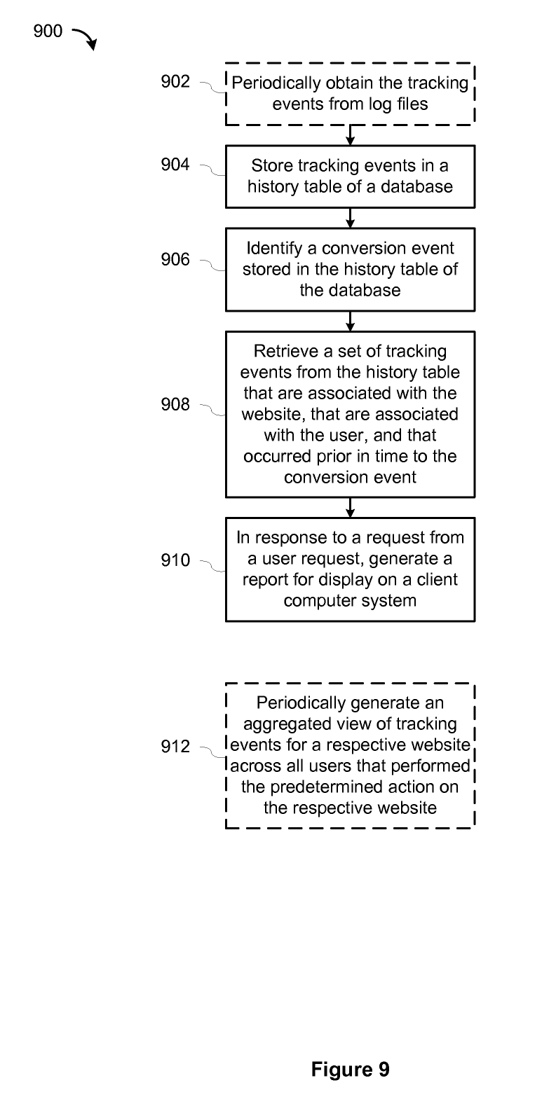

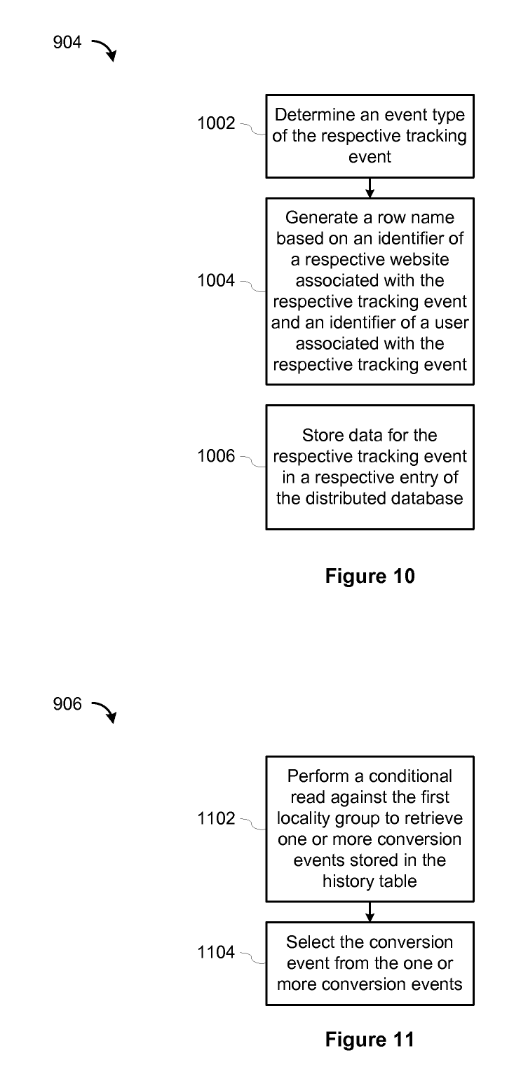

FIG. 3 is a block diagram 300 illustrating the process of generating reports of tracking events, according to some embodiments. The process begins when an event importer module 310 imports tracking events 301 into the history table. In some embodiments, each tracking event 301 includes an identifier of a user associated with the tracking event, a type of tracking event, and a timestamp at which the tracking event was produced. In some embodiments, the tracking events 301 include impression events 302 that are generated when advertisements are displayed to users, click-through events 303 that are generated when users click on advertisements, and conversion events 304 that are generated when users perform a predetermined action on a website associated with an advertisement. In some embodiments, the predetermined action performed by a user is selected from the group consisting of: purchasing a product or service associated with the advertisement, visiting a website associated with the advertisement, and completing a survey. In some embodiments, the event importer 310 imports the tracking events 301 from log files (e.g., the log files 144). In some embodiments, at least one of the impression events 302, the click-through events 303, and the conversion events 304 is stored in a separate log file from the other events. Note that the event importer module 310 is described in more detail with respect to FIGS. 9 and 10.

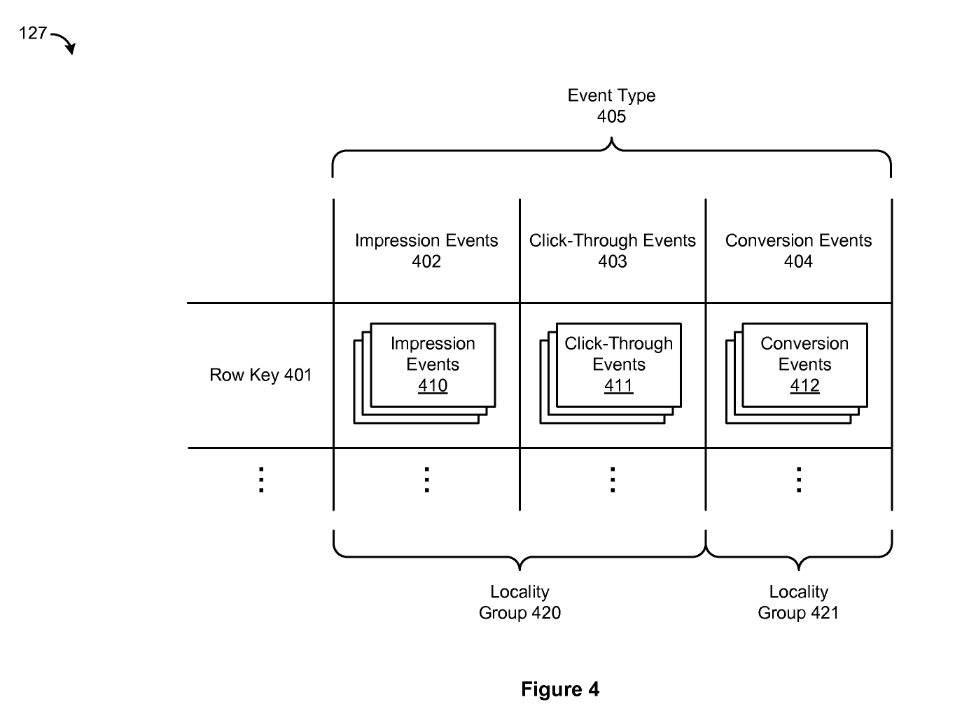

Attention is now directed to FIG. 4, which is a block diagram illustrating the history table 127, according to some embodiments. The history table includes rows and columns that define data fields for storing data values. Each row has a row key (e.g., row key 401). In some embodiments, the row key 401 is based on an identifier for a website (or an identifier of an advertisement associated with the website) and an identifier for a user that produced the event associated with the advertisement. For example, the row key may be generated from a hash of the identifier for the website (or the identifier for the advertisement associated with the website) and the identifier for the user that produced the event associated with the advertisement. In some embodiments, the columns of the history table 127 correspond to event type 405. As illustrated in FIG. 4, the columns include columns for impression events 402, click-through events 403, and conversion events 404. Each column may store one or more tracking events. For example, the column for impression events 402 may store one or more impression events 410, the column for click-through events 403 may store one or more click-through events 411, and the column for conversion events 404 may store one or more conversion events 412. The tracking events in a respective row of the history table 127 correspond to a history of events associated with a particular user and a particular advertisement for a particular website. For example, the row having the row key 401 may correspond to a history of events for a first user and an advertisement of a first website, whereas another row of the history table may correspond to a history of events for the first user and an advertisement for a second website.

For high-volume implementations of the server system 106, the history table 127 may include over a billion rows, of which, on the order of a few million rows are conversion events. Since the conversion events are sparsely populated in the history table 127, identifying a sparse number of conversion events within the history table 127 is a time-consuming task for a traditional relational database management system. Thus, in some embodiments, the history table 127 is stored in a distributed database. In some embodiments, the distributed database is a multi-dimensional sorted map (e.g., BigTable). In these embodiments, data is stored into the database using a mapping of: {row key, event type, timestamp}. For example, a mapping may be {(user ID 1, advertisement ID 1), impression, Jan. 10, 2010}, corresponding to an impression event was recorded on occurred on Jan. 10, 2010 and associated with a user having a user ID of “1” and an advertisement having an advertisement ID of “1”. In some embodiments, to further improve read performance of the distributed database, locality groups are defined based on event types of the tracking events. For example, as illustrated in FIG. 4, locality group 420 includes the columns for the impression events 402 and the click-through events 403, and locality group 421 includes the column for the conversion events 404. By separating the conversion events 404 from the impression events 402 and click-through events 403, a read against the database 127 that requests conversion events can be located efficiently.

Returning to FIG. 3, in order to track events leading up to conversion events, a report module 330 first identifies conversion events and the corresponding tracking events that preceded the conversion events. In some embodiments, the report module 330 performs a conditional read on the history table 127 to identify a set of tracking events that are associated with the conversion events. For example, the report module 330 may perform a conditional read operation that identifies click-though events, impression events, and conversion events for rows of the history table 127 that have one or more conversion events. If the column for the conversion events 404 is designated as a locality group (e.g., as discussed above with respect to FIG. 4), the rows that have one or more conversion events are located efficiently.

After the report module 330 identifies rows having one or more conversion events, the report module 330 generates reports based on the conversion events, the impression events, the click through events.

In some embodiments, the report module 330 periodically reads from the history table 127. In these embodiments, the report module 330 only reads and analyzes tracking events that are new since the prior read from the history table 127.

In some embodiments, a garbage collection module 350 periodically removes tracking events from the history table based on a garbage collection policy. In some embodiments, the garbage collection policy is selected from the group consisting of a time-based garbage collection policy that removes tracking events older than a predetermined age, a user-based garbage collection policy that removes tracking events based on an identifier of a user, and a website-based garbage collection policy that removes tracking events based on an identifier of a website.

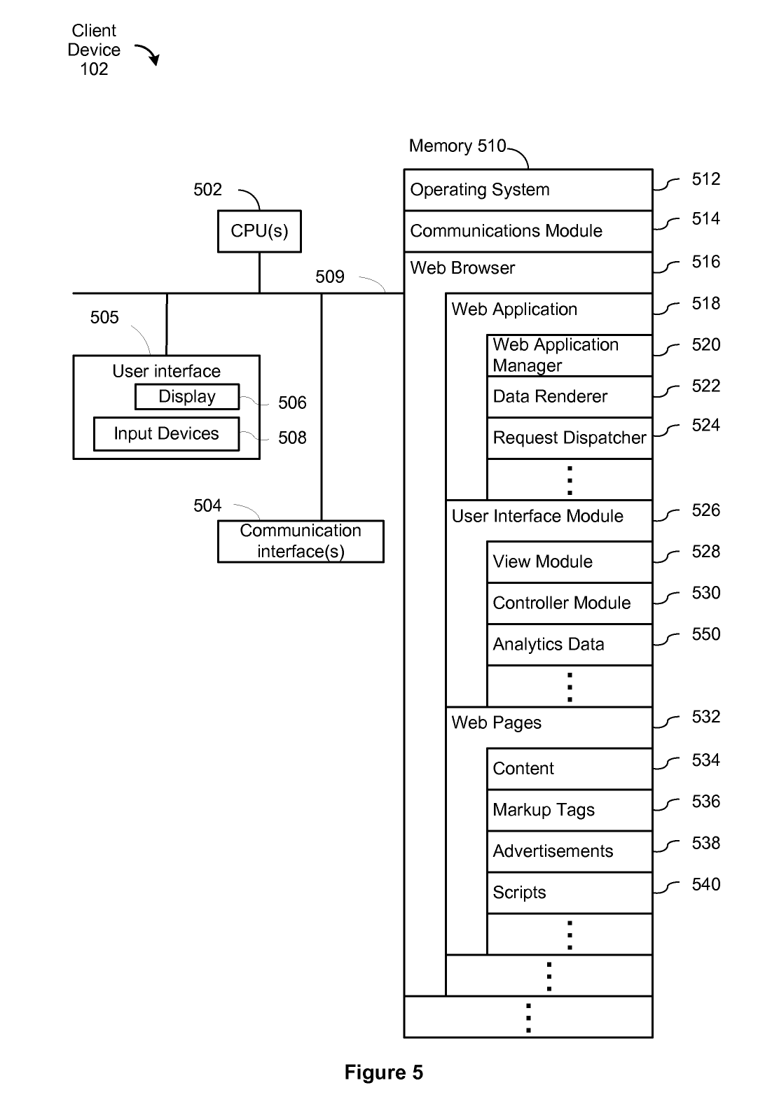

FIG. 5 is a block diagram of a client device 102 for visualizing web traffic data, according to some embodiments. The client device 102 generally includes one or more processing units (CPU's) 502, one or more network or other communications interfaces 504, memory 510, and one or more communication buses 509 for interconnecting these components. The communication buses 509 may include circuitry (sometimes called a chipset) that interconnects and controls communications between components. The client device 502 may optionally include a user interface 505, for instance, a display device 506, input devices 508 (e.g., a keyboard, a mouse, a track pad, a touch-sensitive surface, etc.). Memory 510 may include high speed random access memory, such as DRAM, SRAM, DDR RAM or other random access solid state memory devices; and may also include non-volatile memory, such as one or more magnetic disk storage devices, optical disk storage devices, flash memory devices, or other non-volatile solid state storage devices. Memory 510 may include mass storage that is remotely located from the central processing unit(s) 502. Memory 510, or alternately the non-volatile memory device(s) within memory 510, comprises a computer readable storage medium. Memory 510 or the computer readable storage medium of memory 510 stores the following elements, or a subset of these elements, and may also include additional elements:
an operating system 512 that includes procedures for handling various basic system services and for performing hardware dependent tasks;
a communication module 514 that is used for connecting the client device 102 to other servers or computers including the server system 106, web servers 130, and web server 140, via one or more communication network interfaces 504 (wired or wireless), such as the Internet, other wide area networks, local area networks, and metropolitan area networks and so on;
a web browser 516 (e.g., the client application 112), including a web application manager 520 (e.g., the client assistant 114) for managing the user interactions with the web browser, a data render 522 for supporting the visualization of an analytics report, and a request dispatcher 524 for submitting user requests for new analytics reports;
a user interface module 526, including a view module 528 and a controller module 530, for detecting user instructions to control the visualization of the analytics data 550 (e.g., raw traffic data, reports, graphs, etc.) generated by the server system 106;
web pages 532 including content 534, markup tags 536, advertisements 538 (as described herein), and scripts 540 (e.g., scripts for generating requests for the tracking object 142).

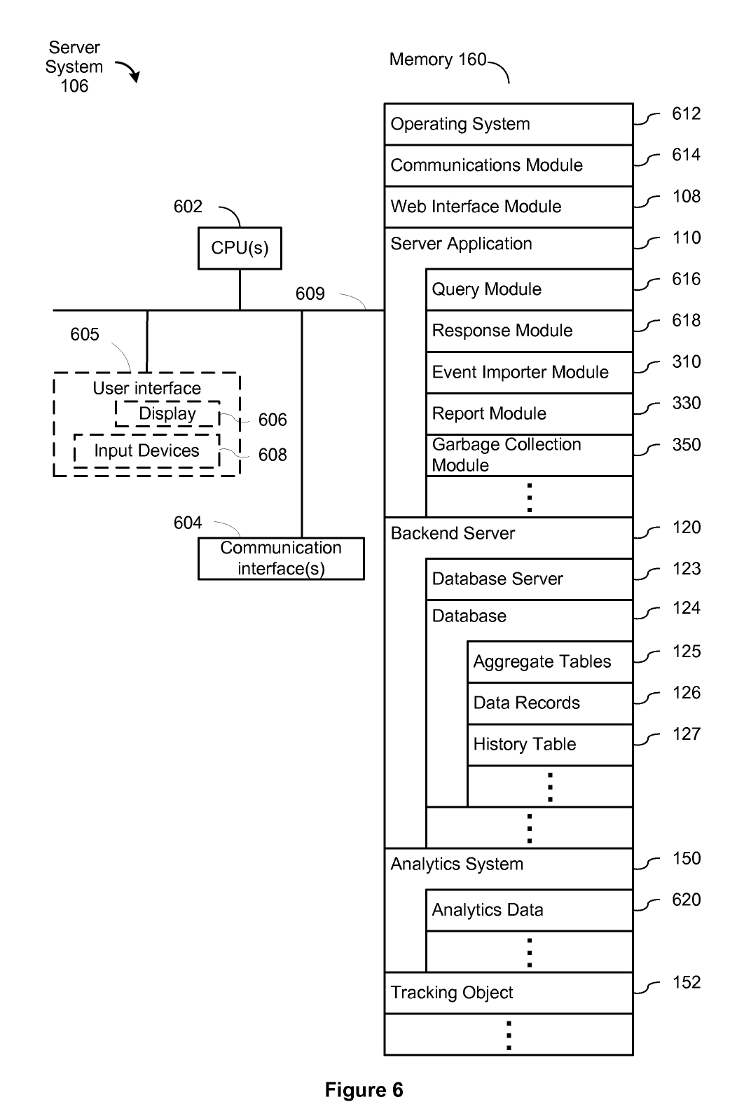

FIG. 6 is a block diagram of a server system 106 for generating views of traffic data to be displayed at a requesting client device, according to some embodiments. The server system 106 generally includes one or more processing units (CPU's) 602, one or more network or other communications interfaces 604, memory 610, and one or more communication buses 609 for interconnecting these components. The server system 106 may optionally include a user interface 605 comprising a display device 606 and input devices 608 (e.g., a keyboard, a mouse, a track pad, etc.). Memory 610 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 610 may optionally include one or more storage devices remotely located from the CPU(s) 602. Memory 610, or alternately the non-volatile memory device(s) within memory 610, comprises a computer readable storage medium. Memory 610 or the computer readable storage medium of memory 610 stores the following elements, or a subset of these elements, and may also include additional elements:
an operating system 612 that includes procedures for handling various basic system services and for performing hardware dependent tasks;
a network communication module 613 that is used for connecting the server system 106 to other computers such as the clients 102 and the web servers 130 and 140 via the communication network interfaces 1104 (wired or wireless) and one or more communication networks, such as the Internet, other wide area networks, local area networks, metropolitan area networks, and so on;
a web interface module 108 for receiving requests from client devices and returning reports in response to the client requests;
a server application 110, including a query module 616 for converting client requests into one or more queries or data filters targeting at the backend 120, a response module 618 for preparing analytics reports based on the response from the backend 120, the event importer module 310 for importing tracking events into the history table 127, the report module 330 for reading events from the history table 127, the garbage collection module 350 for removing stale tracking events, as described herein;
a backend 120 including a database server 123 and data records 126 such as the session data records shown in FIG. 2, and the history table 127 as described herein;
a web analytics system 150 for pre-processing the log files into the sessionized web traffic data records 126 and for generating analytics data 620 (e.g., reports, graphs, etc.) that are displayed to an analytics user (e.g., on the client device 102); and
a tracking object 152 that is a target of requests that provide raw web traffic data to the analytics system 150.

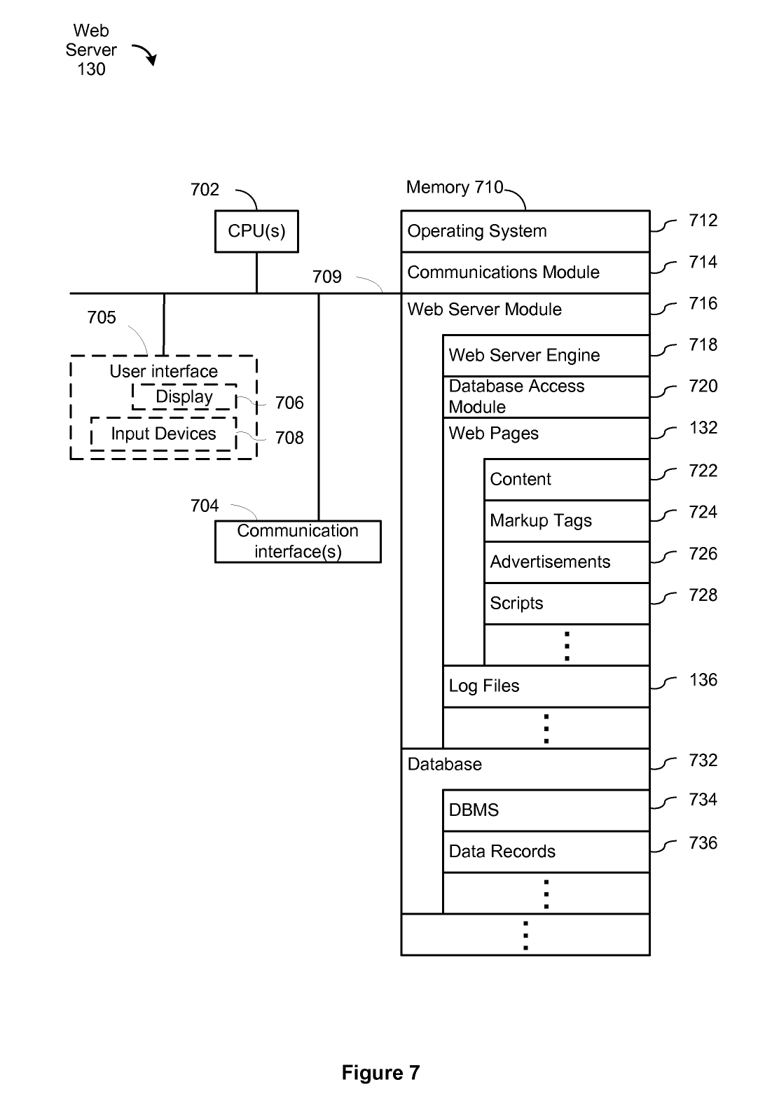

FIG. 7 is a block diagram of a web server 130 for serving web pages to client devices 102, according to some embodiments. The web server 130 generally includes one or more processing units (CPU's) 702, one or more network or other communications interfaces 704, memory 710, and one or more communication buses 709 for interconnecting these components. The web server 130 may optionally include a user interface 705 comprising a display device 706 and input devices 708 (e.g., a keyboard, a mouse, a track pad, etc.). Memory 710 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 710 may optionally include one or more storage devices remotely located from the CPU(s) 702. Memory 710, or alternately the non-volatile memory device(s) within memory 710, comprises a computer readable storage medium. Memory 710 or the computer readable storage medium of memory 710 stores the following elements, or a subset of these elements, and may also include additional elements:
an operating system 712 that includes procedures for handling various basic system services and for performing hardware dependent tasks;
a network communication module 714 that is used for connecting the web server 130 to other computers such as the clients 102, the web server 140, and the server system 106 via the communication network interfaces 704 (wired or wireless) and one or more communication networks, such as the Internet, other wide area networks, local area networks, metropolitan area networks, and so on;
a web server module 716 including a web server engine 718 for receiving and responding to requests for web pages 132 from client devices 102, a database access module 720 for accessing database 732 of the web server 130, web pages 132 including content 722, markup tags 724, advertisements 726, and scripts 728 (e.g., scripts for generating requests for the tracking object 142), log files 136 including data related to accesses made by users of the web server 130, as described herein; and
a database 732 including a database management system (DBMS) 734 for providing an interface to access data records 736 of the database 732.

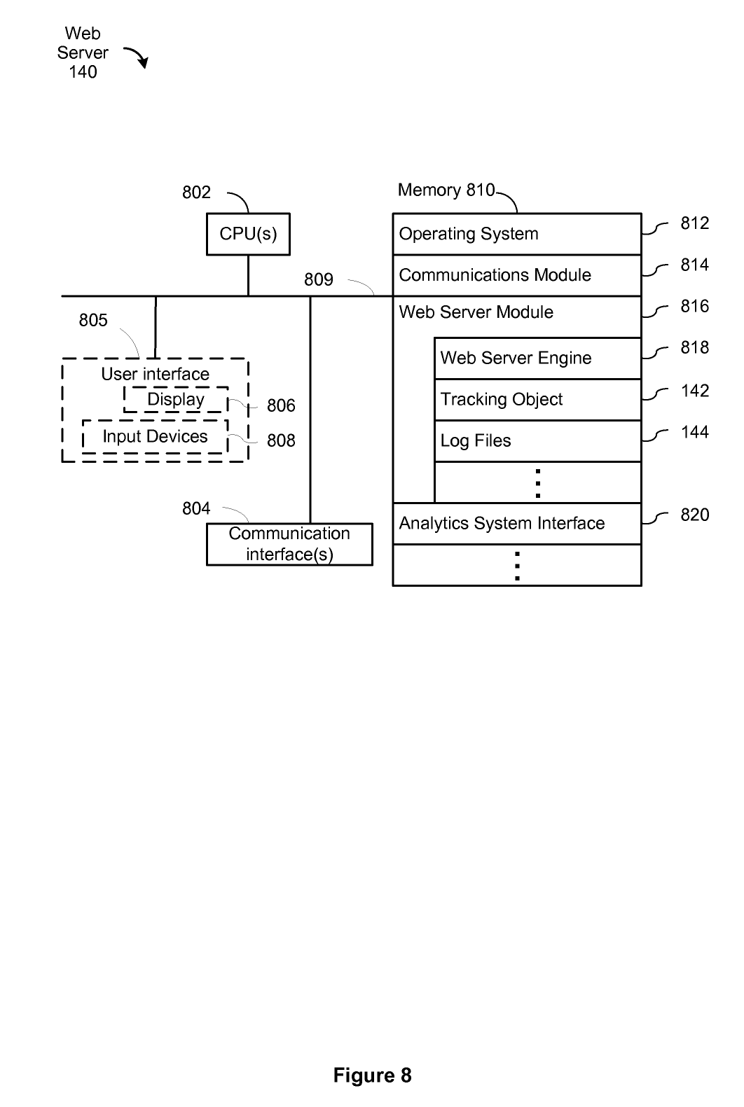

FIG. 8 is a block diagram of a web server 140 for logging accesses by users of web sites hosted on web servers 130, according to some embodiments. The web server 140 generally includes one or more processing units (CPU's) 802, one or more network or other communications interfaces 804, memory 810, and one or more communication buses 809 for interconnecting these components. The web server 140 may optionally include a user interface 805 comprising a display device 806 and input devices 808 (e.g., a keyboard, a mouse, a track pad, etc.). Memory 810 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 810 may optionally include one or more storage devices remotely located from the CPU(s) 802. Memory 810, or alternately the non-volatile memory device(s) within memory 810, comprises a computer readable storage medium. Memory 810 or the computer readable storage medium of memory 810 stores the following elements, or a subset of these elements, and may also include additional elements:
an operating system 812 that includes procedures for handling various basic system services and for performing hardware dependent tasks;
a network communication module 814 that is used for connecting the web server 140 to other computers such as the clients 102, the web servers 80, and the server system 106 via the communication network interfaces 804 (wired or wireless) and one or more communication networks, such as the Internet, other wide area networks, local area networks, metropolitan area networks, and so on;
a web server module 816 including a web server engine 818 for receiving and responding to requests tracking object 142 and logging the requests including custom variable tags included in the request into log files 144; and
an analytics system interface 820 that provides an interface for the server system 106 to access the log files 144.

Each of the above-identified elements in FIGS. 5-8 may be stored in one or more of the previously mentioned memory devices, and corresponds to a set of instructions for performing a function described above when executed by the processors 502, 602, 702, and 802, respectively. The above identified modules or programs (i.e., sets of instructions) need not be implemented as separate software programs, procedures or modules, and thus various subsets of these modules may be combined or otherwise re-arranged in various embodiments. In some embodiments, memory 510, 610, 710, 810 may store a subset of the modules and data structures identified above. Furthermore, memory 510, 610, 710, 810 may store additional modules and data structures not described above.

FIGS. 5-8 are intended more as functional descriptions of the various features of a client device and server system rather than a structural schematic of the embodiments described herein. In practice, and as recognized by those of ordinary skill in the art, items shown separately could be combined and some items could be separated. For example, some items shown separately in FIG. 6 like the web interface module 108 and the server application 110 could be implemented on single servers and single items like the database 124 could be implemented by one or more servers. The actual number of server computers used to implement the server system 106, and how features are allocated among them will vary from one implementation to another, and may depend in part on the amount of data traffic that the system must handle during peak usage periods as well as during average usage periods.

Attention is now directed to FIG. 9, which is a flowchart of a method 900 for tracking conversion events, according to some embodiments. In some embodiments, the event importer module 310 periodically obtains (902) the tracking events from log files.

Next, the event importer module 310 stores (904) tracking events in a history table of a database, wherein the tracking events include conversion events associated with predetermined actions performed by users on websites, and wherein a respective tracking event is associated with a respective user and a respective website. Attention is now directed to FIG. 10, which is a flowchart of a method for storing (904) tracking events in a history table of a database, according to some embodiments. The event importer module 310 determines (1002) an event type of the respective tracking event. Next, the event importer module 310 generates (1004) a row name based on an identifier of a respective website (or an identifier of a respective advertisement of the respective website) associated with the respective tracking event and an identifier of a user associated with the respective tracking event. For example, the row name may be a hash of the identifier of the respective website (or the respective advertisement) and the identifier of the user. The event importer module 310 then stores (1006) data for the respective tracking event in a respective entry of the distributed database, wherein the respective entry has an index based on the row name, the event type, and a timestamp corresponding to a time when the respective tracking event was generated.

Returning to FIG. 9, the report module 330 identifies (906) a conversion event stored in the history table of the database, wherein the conversion event is associated with a predetermined action performed by a user on a website. In some embodiments, the predetermined action performed by the user on the website is in response to an advertisement displayed to the user. Attention is now directed to FIG. 11, which is a flowchart of a method for identifying (906) a conversion event stored in the history table of the database, according to some embodiments. The report module 330 performs (1102) a conditional read against the first locality group to retrieve one or more conversion events stored in the history table. The report module 330 then selects (1104) the conversion event from the one or more conversion events.

Returning to FIG. 9, the report module 330 retrieves (908) a set of tracking events from the history table that are associated with the website (or the advertisement associated with the website), that are associated with the user, and that occurred prior in time to the conversion event. In some embodiments the set of tracking events that are retrieved from the history table include only the tracking events that occurred within a predetermined time interval prior in time to occurrence of the conversion event. For example, consider a conversion event for a website that was produced by actions of a user on Feb. 1, 2010. The report module 330 may then retrieve tracking events (e.g., impression events, click-through events, and/or conversion events) for the website that were produced by actions of the user and that occurred within 30 days before Feb. 1, 2010. Note that other time intervals may be used.

In response to a request from a user request, the report module 330 generates (910) a report for display on a client computer system, wherein the report includes the set of tracking events and the conversion event.

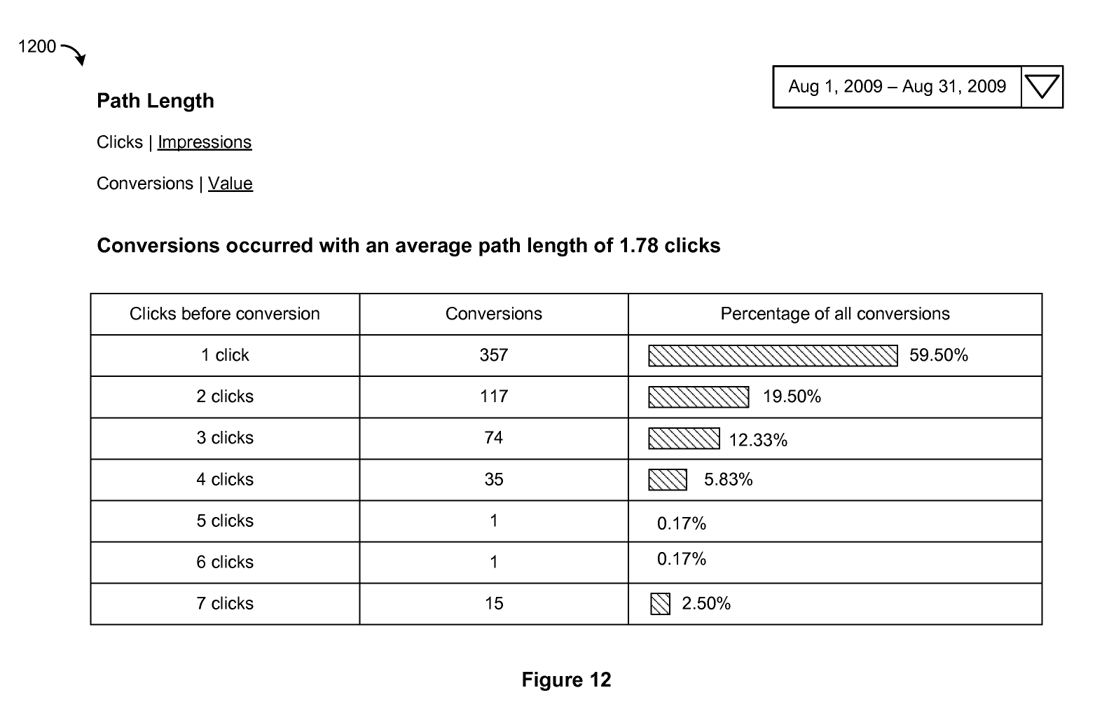

In some embodiments, the report module 330 generates (910) a report for display on a client computer system that includes statistics for conversion events. For example, FIG. 12 is a screenshot 1200 illustrating an exemplary report that summarizes conversion event statistics for a time period between Aug. 1, 2009 and Aug. 31, 2009, according to some embodiments. In this example, the statistics indicate the percentage of all conversions that occurred after a particular number of clicks (e.g., conversions occurred after 1 click in 59.5% of all conversions that occurred within the time period). Note that the report can also be generated based on the number of impressions that occurred before a conversion event. Similarly, the report may be generated based on the monetary value of the products and/or services converted instead of the actual number of conversions.

In some embodiments, the report module 330 periodically generates (912) an aggregated view of tracking events for a respective website across all users that performed the predetermined action on the respective website.

The methods 900-1100 may be governed by instructions that are stored in a computer readable storage medium and that are executed by one or more processors of one or more servers. Each of the operations shown in FIGS. 9-11 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted and/or executable by one or more processors.

Note that although the embodiments described herein are directed to tracking conversion events for advertisements, the embodiments described herein may be applied to tracking other related events. In general, the embodiments described herein may be used to track any sequence of related events that lead to an event satisfying predetermined criteria. For example, the embodiments described herein may be used to track a sequence of search queries submitted by a user that leads to a click event on a particular search result (i.e., the event satisfying the predetermined criteria).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method for tracking conversion events, comprising:
at a computer system including one or more processors and memory storing one or more programs, the one or more processors executing the one or more programs to perform the operations of:
storing tracking events in a history table of a database, wherein the tracking events include conversion events associated with predetermined actions performed by users on websites, wherein a respective tracking event is associated with a respective action produced from a respective user's visit to a respective website, and wherein storing tracking events includes:
determining an event type of the respective tracking event;
generating a row key comprising a combination of an identifier of the respective website and an identifier of the respective user; and
storing data for the respective tracking event in a respective entry of the database, wherein the respective entry is identified by the row key and comprises a plurality of event types and a timestamp corresponding to a time when the respective tracking event was generated;
identifying a conversion event stored in the history table of the database, wherein the conversion event is associated with a predetermined action performed by a user on a website;
retrieving a set of tracking events from the history table that are associated with the website, that are associated with the user, and that occurred prior in time to the conversion event; and
in response to a request from a user request, generating a report for display on a client computer system, wherein the report includes the set of tracking events and the conversion event.

2. The method of claim 1, wherein the respective tracking event is selected from the group consisting of:
a conversion event that is generated when the respective user performs a predetermined action on the respective website;
an impression event that is generated when an advertisement is displayed to a user; and
a click-through event that is generated when a user clicks on an advertisement.

3. The method of claim 1, wherein the predetermined action performed by the user is selected from the group consisting of:
purchasing a product or service associated with an advertisement;
visiting the website associated with the advertisement; and
completing a survey.

4. The method of claim 1, wherein prior to storing the tracking events in the history table of the database, the method further comprises periodically obtaining the tracking events from log files.

5. The method of claim 1, wherein the database is a distributed database.

6. The method of claim 5, wherein the distributed database is a multi-dimensional sorted map.

7. (canceled)

8. The method of claim 5, wherein the method further comprises designating locality groups of the distributed database based on the event types of the tracking events.

9. The method of claim 8,
wherein a first locality group includes conversion events; and
wherein a second locality group includes impression events and click-through events.

10. The method of claim 9, wherein identifying the conversion event stored in the history table of the database includes:
performing a conditional read against the first locality group to retrieve one or more conversion events stored in the history table; and
selecting the conversion event from the one or more conversion events.

11. The method of claim 1, wherein the method further comprises periodically generating an aggregated view of tracking events for a respective website across all users that performed the predetermined action on the respective website.

12. The method of claim 1, wherein the method further comprises periodically removing tracking events from the history table based on a garbage collection policy.

13. The method of claim 12, wherein the garbage collection policy is selected from the group consisting of:
a time-based garbage collection policy that removes tracking events older than a predetermined age;
a user-based garbage collection policy that removes tracking events based on an identifier of a user; and
a website-based garbage collection policy that removes tracking events based on an identifier of a website.

14. The method of claim 1, wherein the website is selected from the group consisting of:
an e-commerce website; an auction website;
a multimedia-download website;
a charitable contribution website; and
a survey website.

15. The method of claim 1, wherein the set of tracking events that are retrieved from the history table include only the tracking events that occurred within a predetermined time interval prior in time to occurrence of the conversion event.

16. A system for tracking conversion events, comprising:
one or more processors;
memory; and
one or more programs stored in the memory, the one or more programs comprising instructions to:
store tracking events in a history table of a database, wherein the tracking events include conversion events associated with predetermined actions performed by users on websites, and wherein a respective tracking event is associated with a respective action produced from a respective user's visit to a respective website, and wherein the instructions to store tracking events include instructions to:
determine an event type of the respective tracking event;
generate a row key comprising a combination of an identifier of the respective website and an identifier of the respective user; and
store data for the respective tracking event in a respective entry of the database, wherein the respective entry is identified by the row key and comprises a plurality of event types and a timestamp corresponding to a time when the respective tracking event was generated;
identify a conversion event stored in the history table of the database, wherein the conversion event is associated with a predetermined action performed by a user on a website;
retrieve a set of tracking events from the history table that are associated with the website, that are associated with the user, and that occurred prior in time to the conversion event; and
in response to a request from a user request, generate a report for display on a client computer system, wherein the report includes the set of tracking events and the conversion event.

17. A non-transitory computer readable storage medium storing one or more programs configured for execution by a computer, the one or more programs comprising instructions to:
store tracking events in a history table of a database, wherein the tracking events include conversion events associated with predetermined actions performed by users on websites, and wherein a respective tracking event is associated with a respective action produced from a respective user's visit to a respective website, and wherein the instructions to store tracking events include instructions to:
determine an event type of the respective tracking event;
generate a row key comprising a combination of an identifier of the respective website and an identifier of the respective user; and
store data for the respective tracking event in a respective entry of the database, wherein the respective entry is identified by the row key and comprises a plurality of event types and a timestamp corresponding to a time when the respective tracking event was generated;
identify a conversion event stored in the history table of the database, wherein the conversion event is associated with a predetermined action performed by a user on a website;
retrieve a set of tracking events from the history table that are associated with the website, that are associated with the user, and that occurred prior in time to the conversion event; and
in response to a request from a user request, generate a report for display on a client computer system, wherein the report includes the set of tracking events and the conversion event.

18. The computer-implemented method of claim 1 wherein the generating step comprises:
generating a row key comprising a hash of an identifier of the respective website and an identifier of the respective.

19. The system of claim 16 for tracking conversion events, wherein the instructions to store tracking events include instructions to:
generate a row key comprising a hash of an identifier of the respective website and an identifier of the respective user.
